(19) United States
(12) Patent Application Publication
(10) Pub. No.: US 2026/0072429 A1
(43) Pub. Date: Mar. 12, 2026

(54) AEROENGINE REMAINING USEFUL LIFE PREDICTION METHOD

(71) Applicant: XI'AN JIAOTONG UNIVERSITY, Xi'an (CN)

(72) Inventors: Ruqiang YAN, Xi'an (CN); Zheng ZHOU, Xi'an (CN); Laihao YANG, Xi'an (CN); Chenye HU, Xi'an (CN)

(21) Appl. No.: 19/250,621

(22) Filed: Jun. 26, 2025

(30) Foreign Application Priority Data
Sep. 11, 2024 (CN) 2024112737597

(51) Int. Cl. G05B 23/02; G06F 17/14

(52) U.S. Cl. CPC G05B 23/0283; G05B 23/0254; G06F 17/14

(57) ABSTRACT

An aeroengine remaining useful life prediction method based on a neural ordinary differential equation under symmetric regularization includes the steps of: collecting monitoring parameters of a full-lifecycle of an aeroengine with sensors; establishing a first-order neural ordinary differential equation to perform continuous temporal modeling on a degradation process in a latent variable space, calculating a residual signal as a time-varying signal; establishing a Fourier neural operator to approximate a transfer function of a physical system, mapping an operating condition parameter and a latent variable to a sensor response parameter, so as to construct a loss function of the neural network; considering a time-scale transformation between different degradation processes, constructing a symmetry regularization term to constrain the invariance of the neural ordinary differential equation to the time-scale transformation, obtaining a latent variable process with a consistent structure.

### CROSS-REFERENCE TO RELATED APPLICATION

This application claims priority from the Chinese patent application 2024112737597 filed Sep. 11, 2024, the content of which are incorporated herein in the entirety by reference.

### TECHNICAL FIELD

The present disclosure relates to the technical field of aeroengines, and in particular to an aeroengine remaining useful life prediction method based on a neural ordinary differential equation under symmetric regularization.

### BACKGROUND

The health monitoring and remaining useful life prediction of aeroengines are crucial for maintaining operational safety of the equipment. Understanding latent variable modeling is vital for remaining useful life prediction, as it directly reveals how a system degrades over time, with similarities in its functionality and health indicators. The latent variable processes or health indicators not only display the current state but also track degradation trajectories, providing predictive information for potential faults. Latent variables are typically represented as vectors, encompassing a wide range of degradation features, whereas health indicators are usually scalars, providing a global measure for the overall system. Both have attributes such as trendiness and monotonicity. However, traditional health indicator methods rely on post-processing techniques to normalize scalars between 0 and 1, which neglects the variability among different degradation processes within a fleet of equipment. In contrast, the neural ordinary differential equation treats the variability among different degradation processes as equivalent time-scale transformations between degradation trajectories, thus learning a consistent latent variable structure while preserving the variability. Therefore, from the concept of physical symmetry, the neural ordinary differential equation is an invariant function to this equivalent time-scale transformation, providing consistent latent variable processes for remaining useful life prediction without the need for additional normalization post-processing.

The above information disclosed in the Background section is only for enhancement of understanding of the background of the disclosure and therefore may contain information that does not constitute the prior art that is well known to those of ordinary skill in the art.

### SUMMARY

The present disclosure provides an aeroengine remaining useful life prediction method based on a neural ordinary differential equation under symmetric regularization. The method models the degradation process of the system in the latent variable space using the first-order neural ordinary differential equation and Fourier neural operator, and takes into account the time-scale transformations between different degradation processes. Based on the invariance condition of the first-order ordinary differential equation, a symmetry regularization term is constructed to constrain the invariance of the neural ordinary differential equation to time-scale transformations, thereby obtaining a latent variable process with a consistent structure. This latent variable process is then utilized for remaining useful life prediction, and the remaining useful life on the test sample set is estimated based on nearest neighbor samples.

An aeroengine remaining useful life prediction method based on a neural ordinary differential equation under symmetric regularization includes:
Step a, collecting monitoring parameters of a full-lifecycle of an aeroengine with sensors, the monitoring parameters including outlet temperatures and air pressures of a compressor and a turbine, performing temporal segmentation on the monitoring parameters according to a number of flight cycles, obtaining samples of fixed length through downsampling and zero-padding, respectively constructing a training sample set and a test sample set, and performing normalization processing;
Step b, establishing a first-order neural ordinary differential equation to perform continuous temporal modeling on a degradation process in a latent variable space, calculating a residual signal as a time-varying signal to enhance the representation capability of the neural ordinary differential equation, so that a solution of the equation depends simultaneously on an initial value and the time-varying residual signal;
Step c, establishing a Fourier neural operator to approximate a transfer function of a physical system, mapping an operating condition parameter and a latent variable to a sensor response parameter, so as to construct a loss function of the neural network;
Step d, considering time-scale transformation between different degradation processes, based on an invariance condition of the first-order ordinary differential equation, constructing a symmetry regularization term to constrain the invariance of the neural ordinary differential equation to the time-scale transformation, obtaining a latent variable process with a consistent structure; and
Step e, inputting the training sample set and the test sample set into the neural network to obtain latent variable processes corresponding to the training sample set and the test sample set, respectively, estimating the remaining useful life of the test sample set according to nearest neighbor samples in the training sample set.

For the aeroengine remaining useful life prediction method based on a neural ordinary differential equation under symmetric regularization, in Step a, the monitoring parameters X=[x₁, . . . , x_{N}] of the full-lifecycle are divided by the number of flight cycles, each cycle is divided into one sample, each sample is a multivariate time series denoted as xᵢ ∈R^{p*T}^{ᵢ}, the number of variables p is the number of sensor monitoring variables, and a time length Tᵢ of each sample is 1353 time steps through downsampling and zero-padding; a mean and a variance are calculated on the training sample set to normalize the samples to within a range of [0, 1], and the mean and variance are applied to the test sample set for normalization.

For the aeroengine remaining useful life prediction method based on a neural ordinary differential equation under symmetric regularization, in Step b, the first-order neural ordinary differential equation is established in a form of:

$${z}_{i} = {z}_{0} + {\int }_{0}^{i} f ( t , {z}_{t} , Δ {x}_{i} ) dt , \qquad {z}_{0} = 0 ,$$

wherein, zᵢ∈R^{d} is an latent variable, which is used for approximating a real but unknown degradation process, i represents the number of cycles of the aeroengine, i.e., the health state of each cycle is represented by a zᵢ vector, d is the dimension of the latent variable; z₀ is an initial value of the ordinary differential equation, and is set to 0 to represent an initial value state of the degradation process; t is an integral variable; ƒ is a neural network, which is used for describing the temporal relationship of the latent variable; Δxᵢ is a residual signal, by adding the time-varying residual signal, the solution of the equation becomes dependent on both the initial value and the time-varying signal, wherein a specific functional form of the neural network ƒ is:

$$\frac{dz ( t )}{dt} = f ( t , z ( t ) , Δ x ( t ) ) = {h}_{ϑ} ( Δ x ( t ) ) \cdot {f}_{φ} ( t , z ( t ) )$$

wherein, h_{ϑ} is an encoder network, consisting of three layers of residual connection network and two non-linear dimensionality reduction layers, the network reduces high-dimensional signals to low-dimensional features, an activation function for a final output layer of h_{ϑ} is selected to be a tanh function; ƒ_{φ} is a multi-layer non-linear perceptron, consisting of three linear layers and non-linear activation functions, the activation function of an intermediate layer is selected as a ReLU function, and the activation function of an output layer is selected as a tanh function, and the tanh function constrains value ranges of h_{ϑ} and ƒ_{φ} within a bounded interval, ensuring that they satisfy the Lipschitz condition; and ϑ and φ are parameters of the neural network.

For the aeroengine remaining useful life prediction method based on a neural ordinary differential equation under symmetric regularization, the residual signal is the residual between an actual signal and a signal in an ideal health state:

$$Δ {x}_{i} = {x}_{i} - {x}_{i}^{′} ,$$

wherein,

$${x}_{i}^{′}$$

is the monitoring parameter in the ideal health state, which is controlled only by the operating condition parameter wᵢ, an independent Fourier neural operator is constructed to approximate a system transfer function in the ideal health state:

$${x}_{j} = {FNO}^{′} ( {w}_{j} ) , j = 1 , 2 , … , m ,$$

wherein, j represents an observed sequence number of the health state, with a maximum value of m, FNO′ is the system transfer function in the ideal health state, then FNO′ is applied to a full-lifecycle sequence to obtain the monitoring parameter in the ideal health state:

$${x}_{i}^{′} = {FNO}^{′} ( {w}_{i} ) , i = 1 , 2 … , N .$$

For the aeroengine remaining useful life prediction method based on a neural ordinary differential equation under symmetric regularization, in Step c, the Fourier neural operator constructs a mapping from the operating condition parameter and the latent variable to the sensor monitoring parameter:

$${\hat{x}}_{i} = FNO ( {w}_{i} , {z}_{i} ) ,$$

wherein, wᵢ∈R^{S*T}^{ᵢ} represents the operating condition parameter, S is the number of the operating condition parameters, zᵢ is the latent variable, \hat{x}ᵢ is the reconstructed sensor monitoring parameter, and FNO is the Fourier neural operator, based on the actual signal xᵢ and the reconstructed signal \hat{x}ᵢ, a loss function of the neural network is obtained as

$${‖ {x}_{i} - {\hat{x}}_{i} ‖}_{2}^{2} ,$$

the Fourier neural operator FNO consists of a lifting layer, an iterative Fourier layer, and a projection layer, and the lifting layer maps the low-dimensional latent variable zᵢ to a high dimensional space; the iterative Fourier layer consists of four forward and inverse Fourier transforms, in each iteration, an input variable undergoes a Fourier forward transform, followed by a linear transformation, and finally a Fourier inverse transform; the projection layer finally maps a feature to a signal space, i.e., the reconstructed signal \hat{x}ᵢ.

For the aeroengine remaining useful life prediction method based on a neural ordinary differential equation under symmetric regularization, in Step d, the time-scale transformation between different degradation processes involves the mutual conversion of these processes through scale transformations along the time axis, an invariance condition of the first-order ordinary differential equation is that there exists one equivalence set of solutions of the first-order ordinary differential equation, the elements in the equivalence set are generated by an equivalent transformation, all the elements in the equivalence set are solutions of the ordinary differential equation, the ordinary differential equation is an invariant function of the equivalent transformation, the variable

$$z = ( t , z , \frac{dz}{dt} )$$

is defined as the solution of the neural ordinary differential equation

$${F}_{θ} ( z ) = {F}_{θ} ( t , z , \frac{dz}{dt} ) = \frac{dz}{dt} - {f}_{x , θ} ( t , z ) = 0 , and θ = \{ ϑ , φ \}$$

is the parameter of the neural network, the invariance condition is as follows:

$${F}_{θ}^{*} ( z ) = {F}_{θ}^{*} ( gz ) ,$$

wherein, g∈G is the time-scale transformation;

$${F}_{θ}^{*}$$

is an ultimately desired invariant function, i.e., both z and gz are the solutions of

$${F}_{θ}^{*}$$

and a set of equivalent solutions is generated by applying the transformation g∈G to z,
by using a Taylor transformation, the above invariance condition is deduced as:

$${XF}_{θ} = ξ ( z ) \frac{\partial }{\partial z} {F}_{θ} = 0 ,$$

wherein,

$$ξ ( z ) = {[ \frac{\partial {g}_{s} ( z )}{\partial s} ]}_{s = 0}$$

is a vector field of the time-scale transformation g, s is the parameter of the time-scale transformation, and

$$X = ξ ( z ) \frac{\partial }{\partial z}$$

is an infinitesimal generator.

For the aeroengine remaining useful life prediction method based on a neural ordinary differential equation under symmetric regularization, an expression of the infinitesimal generator is denoted as

$$X = ξ ( t , z ) \frac{\partial }{\partial t} + η ( t , z ) \frac{\partial }{\partial z} ,$$

and ξ and η are vector fields of the variables t and z, respectively, considering the first-order differential term

$$\frac{dz}{dt} ,$$

the invariance condition takes into account the first-order prolongation of the infinitesimal generator, denoted as X⁽¹⁾, and the invariance condition is derived as follows:

$${X}^{( 1 )} {F}_{θ} {\vert}_{{F}_{θ} = 0} = 0 ,$$

wherein

$${X}^{( 1 )} = X + {η}_{1} ( t , z ) \frac{\partial }{\partial {z}^{1}} = ξ \frac{\partial }{\partial t} + η \frac{\partial }{\partial z} + ( \frac{\partial η}{\partial t} + ( \frac{\partial η}{\partial z} - \frac{\partial ξ}{\partial t} ) {z}^{1} - {( {z}^{1} )}^{2} \frac{\partial ξ}{\partial z} ) \frac{\partial }{\partial {z}^{1}} , and {z}^{1} = \frac{dz}{dt} ,$$

hence, the invariance condition is simplified as:

$${X}^{( 1 )} {F}_{θ} = \frac{\partial η}{\partial t} + ( \frac{\partial η}{\partial z} - \frac{\partial ξ}{\partial t} ) {f}_{x , θ} - {( {f}_{x , θ} )}^{2} \frac{\partial ξ}{\partial z} - ξ \frac{\partial {f}_{x , θ}}{\partial t} - η \frac{\partial {f}_{x , θ}}{\partial z} = 0 ,$$

wherein, ξ and η are vector fields of the variables t and z, respectively, and they are determined by the form of the equivalent transformation g.

For the aeroengine remaining useful life prediction method based on a neural ordinary differential equation under symmetric regularization, the latent variable z is a power function characterizing the degradation process, z(t)=kt^{α}, k, and α are the function coefficients, then the vector fields ξ and η are obtained as follows:

$$\{ \begin{matrix}\tilde{t} = {e}^{s} t \\ \tilde{z} = {e}^{- s α} z\end{matrix} ⇒ \{ \begin{matrix}ξ = \frac{\partial \tilde{t} ( t \vert s )}{\partial s} {\vert}_{s = 0} = {e}^{s} t {\vert}_{s = 0} = t \\ η = \frac{\partial \tilde{z} ( z \vert s )}{\partial s} {\vert}_{s = 0} = - α {e}^{- α s} z {\vert}_{s = 0} = - α z\end{matrix} ,$$

wherein, \tilde{t} and \tilde{z} are equivalent solutions after the time-scale transformation, and the vector fields ξ and η are substituted into the invariance condition to obtain the symmetry regularization:

$${J}_{ODE} = ‖ t \frac{\partial {f}_{x , θ}}{\partial t} - α z \frac{\partial {f}_{x , θ}}{\partial z} + 2 {f}_{x , θ} + 2 α {f}_{x , θ} ‖ ,$$

or, z is an exponential function, and the corresponding symmetry regularization is:

$${J}_{ODE} = ‖ t \frac{\partial {f}_{x , θ}}{\partial t} - {e}^{- 1} z \frac{\partial {f}_{x , θ}}{\partial z} + 2 {f}_{x , θ} + 2 {e}^{- 1} {f}_{x , θ} ‖$$

it is found that both are able to be described with a same expression:

$${J}_{ODE} = ‖ t \frac{\partial {f}_{x , θ}}{\partial t} + 2 {f}_{x , θ} + α ( 2 {f}_{x , θ} - z \frac{\partial {f}_{x , θ}}{\partial z} ) ‖$$

wherein, α is the function coefficient.

For the aeroengine remaining useful life prediction method based on a neural ordinary differential equation under symmetric regularization, in Step e, the training sample set is input into the neural network under the symmetry regularization to obtain the latent variable process corresponding to the training sample set, and by combining the time information, the remaining useful life of the latent variable process in the test sample set is estimated with a k-nearest neighbor algorithm to obtain remaining useful life sample pairs [(z₁,y₁), . . . , (z_{N},y_{N})], wherein yᵢ is a remaining useful life label.

For the aeroengine remaining useful life prediction method based on a neural ordinary differential equation under symmetric regularization, in Step e, the neural network includes two parts of the neural ordinary differential equation and the Fourier neural operator, wherein, the neural ordinary differential equation models the latent variable zᵢ, and the Fourier neural operator maps the latent variable z; to the signal space, i.e., the reconstructed signal \hat{x}ᵢ; then finally an optimization objective for all the parameters consists of a reconstruction loss

$${‖ {x}_{i} - {\hat{x}}_{i} ‖}_{2}^{2}$$

and symmetry regularization J_{ODE}, since the latent variable process is restricted to one continuous bounded function space, the general approximation theorem of neural networks guarantees convergence.

Compared with the prior art, the present disclosure has the following advantages: the present disclosure constructs the neural ordinary differential equation to model the degradation process in the latent variable space; based on the invariance condition of the first-order ordinary differential equation, symmetry regularization is constructed, making the neural network an invariant function for equivalent transformations between different degradation processes. This provides a consistent latent variable process for remaining useful life prediction without requiring additional normalization post-processing. By modeling the degradation process in the latent variable space using the neural ordinary differential equation and constructing the symmetry regularization based on the invariance condition, the solution space of the neural ordinary differential equation is constrained, thus ultimately enabling the aeroengine remaining useful life prediction.

### BRIEF DESCRIPTION OF DRAWINGS

Various additional advantages and benefits of the present disclosure will become apparent to those of ordinary skill in the art upon reading the following detailed description of the preferred embodiments. The drawings are only for the purpose of illustrating preferred embodiments and are not to be considered as limitations to the disclosure. It is obvious that the drawings described below are merely some embodiments of the present disclosure, for those of ordinary skill in the art, other drawings can also be obtained according to these drawings without paying creative effort. Also, like reference numerals refer to like parts throughout the drawings.

In the drawings:

FIG. 1 is a flow chart of an aeroengine remaining useful life prediction method based on a neural ordinary differential equation under symmetric regularization according to an embodiment of the present disclosure;

FIG. 2 is a schematic diagram illustrating the time-scale transformation of the degradation process according to an embodiment of the present disclosure;

FIG. 3 is a schematic diagram illustrating the estimation of the latent variable process according to an embodiment of the present disclosure;

FIG. 4 is a schematic diagram illustrating the comparison of latent variable processes for the aeroengine according to an embodiment of the present disclosure;

FIG. 5 is a schematic diagram illustrating the aeroengine remaining useful life prediction according to an embodiment of the present disclosure; and

FIG. 6 is a schematic diagram illustrating the convergence process of neural network training according to an embodiment of the present disclosure.

The present disclosure is further explained below with reference to the accompanying drawings and examples.

### DETAILED DESCRIPTION OF THE INVENTION

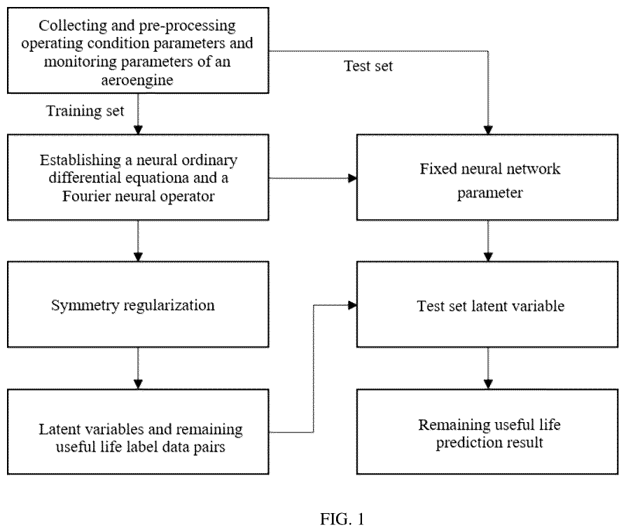

Specific embodiments of the disclosure will be described in more detail below with reference to the accompanying FIGS. 1 to 6. While specific embodiments of the disclosure are illustrated in the accompanying drawings, it should be understood that the disclosure may be embodied in various forms and should not be construed as limited to the embodiments set forth herein. Rather, these embodiments are provided so that the present disclosure will be more fully understood, and will fully convey the scope of the disclosure to those skilled in the art.

It should be noted that certain terms are used throughout the description and claims to refer to certain components. It will be appreciated by those skilled in the art that different terms may be used to refer to the same component. The present description and claims do not use differences in terms as a way to distinguish components, but use differences in functions of components as a criterion for distinguishing them. As mentioned throughout the description and claims, “include” or “including” is an open term, it should be construed as “including but not limited to”. The following description is to describe preferred embodiments for carrying out the disclosure, but the description is for the purpose of the general principles of the description and is not intended to limit the scope of the disclosure. The scope of the disclosure is intended as defined in the appended claims.

In order to facilitate understanding of the embodiments of the present disclosure, specific embodiments will be further explained below with reference to the accompanying drawings as examples, and each of the accompanying drawings does not constitute a limitation of the embodiments of the present disclosure.

As shown in FIGS. 1 to 5, the aeroengine remaining useful life prediction method based on a neural ordinary differential equation under symmetric regularization includes the following steps:
Step a, monitoring parameters of a full-lifecycle of an aeroengine are collected with sensors, the monitoring parameters including outlet temperatures and air pressures of a compressor and a turbine, temporal segmentation is performed on the monitoring parameters according to a number of flight cycles, samples of fixed length are obtained through downsampling and zero-padding, a training sample set and a test sample set are respectively constructed, and normalization processing is performed;
Step b, a first-order neural ordinary differential equation is established to perform continuous temporal modeling on a degradation process in a latent variable space, a residual signal is calculated as a time-varying signal to enhance the representation capability of the neural ordinary differential equation, so that a solution of the equation depends simultaneously on an initial value and the time-varying residual signal;
Step c, a Fourier neural operator is established to approximate a transfer function of a physical system, an operating condition parameter and a latent variable are mapped to a sensor response parameter, so as to construct a loss function of the neural network;
Step d, a time-scale transformation between different degradation processes is considered, based on an invariance condition of the first-order ordinary differential equation, a symmetry regularization term is constructed to constrain the invariance of the neural ordinary differential equation to the time-scale transformation, and a latent variable process with a consistent structure is obtained; and
Step e, the training sample set and the test sample set are input into the neural network to obtain latent variable processes corresponding to the training sample set and the test sample set, respectively, the remaining useful life of the test sample set is estimated according to nearest neighbor samples in the training sample set.

In a preferred embodiment of the aeroengine remaining useful life prediction method based on a neural ordinary differential equation under symmetric regularization, in Step a, the monitoring parameters X=[x₁, . . . , X_{N}] of the full-lifecycle are divided by the number of flight cycles, each cycle is divided into one sample, each sample is a multivariate time series denoted as xᵢ ∈R^{p*T}^{ᵢ}, the number of variables p is the number of sensor monitoring variables, and a time length Tᵢ of each sample is 1353 time steps through downsampling and zero-padding; a mean and a variance are calculated on the training sample set to normalize the samples to within a range of [0, 1], and the mean and variance are applied to the test sample set for normalization.

In a preferred embodiment of the aeroengine remaining useful life prediction method based on a neural ordinary differential equation under symmetric regularization, in Step b, the first-order neural ordinary differential equation is established in a form of:

$${z}_{i} = {z}_{0} + {\int }_{0}^{i} ϑ {z}_{0} = 0 ,$$

wherein, zᵢ∈R^{d} is an latent variable, which is used for approximating a real but unknown degradation process, i represents the number of cycles of the aeroengine, i.e., the health state of each cycle is represented by a zᵢ vector, d is the dimension of the latent variable; z₀ is an initial value of the ordinary differential equation, and is set to 0 to represent an initial value state of the degradation process; t is an integral variable; ƒ is a neural network, which is used for describing the temporal relationship of the latent variable; Δxᵢ is a residual signal, by adding the time-varying residual signal, the solution of the equation becomes dependent on both the initial value and the time-varying signal, wherein a specific functional form of the neural network ƒ is:

$$\frac{dz ( t )}{dt} = f ( t , z ( t ) Δ x ( t ) ) = {h}_{ϑ} ( Δ x ( t ) ) \cdot {f}_{φ} ( t , z ( t ) )$$

wherein, h_{ϑ} is an encoder network, consisting of three layers of residual connection network and two non-linear dimensionality reduction layers, the network reduces high-dimensional signals to low-dimensional features, an activation function for a final output layer of h_{ϑ} is selected to be a tanh function; ƒ_{φ} is a multi-layer non-linear perceptron, consisting of three linear layers and non-linear activation functions, the activation function of an intermediate layer is selected as a ReLU function, and the activation function of an output layer is selected as a tanh function, and the tanh function constrains value ranges of h_{ϑ} and ƒ_{φ} within a bounded interval, ensuring that they satisfy the Lipschitz condition; and ϑ and φ are parameters of the neural network.

In a preferred embodiment of the aeroengine remaining useful life prediction method based on a neural ordinary differential equation under symmetric regularization, the residual signal is the residual between an actual signal and a signal in an ideal health state:

$$Δ {x}_{i} = {x}_{i} - {x}_{i}^{′} ,$$

wherein,

$${x}_{i}^{′}$$

is the monitoring parameter in the ideal health state, which is controlled only by the operating condition parameter wᵢ, an independent Fourier neural operator is constructed to approximate a system transfer function in the ideal health state:

$${x}_{j} = {FNO}^{′} ( {w}_{j} ) , j = 1 , 2 , … , m ,$$

wherein, j represents an observed sequence number of the health state, with a maximum value of m, FNO′ is the system transfer function in the ideal health state, then FNO′ is applied to a full-lifecycle sequence to obtain the monitoring parameter in the ideal health state:

$${x}_{i}^{′} = {FNO}^{′} ( {w}_{i} ) , i = 1 , 2 … , N .$$

In a preferred embodiment of the aeroengine remaining useful life prediction method based on a neural ordinary differential equation under symmetric regularization, in Step c, the Fourier neural operator constructs a mapping from the operating condition parameter and the latent variable to the sensor monitoring parameter:

$${\hat{x}}_{i} = FNO ( {w}_{i} , {z}_{i} ) ,$$

wherein, wᵢ∈R^{S*T}^{ᵢ} represents the operating condition parameter, S is the number of the operating condition parameters, zᵢ is the latent variable, \hat{x}ᵢ is the reconstructed sensor monitoring parameter, and FNO is the Fourier neural operator, based on the actual signal xᵢ and the reconstructed signal \hat{x}ᵢ, a loss function of the neural network is obtained as

$${‖ {x}_{i} - {\hat{x}}_{i} ‖}_{2}^{2} ,$$

the Fourier neural operator FNO consists of a lifting layer, an iterative Fourier layer, and a projection layer, and the lifting layer maps the low-dimensional latent variable zᵢ to a high dimensional space; the iterative Fourier layer consists of four forward and inverse Fourier transforms, in each iteration, an input variable undergoes a Fourier forward transform, followed by a linear transformation, and finally a Fourier inverse transform; the projection layer finally maps a feature to a signal space, i.e., the reconstructed signal \hat{x}ᵢ.

In a preferred embodiment of the aeroengine remaining useful life prediction method based on a neural ordinary differential equation under symmetric regularization, in Step d, the time-scale transformation between different degradation processes involves the mutual conversion of these processes through scale transformations along the time axis, an invariance condition of the first-order ordinary differential equation is that there exists one equivalence set of solutions of the first-order ordinary differential equation, the elements in the equivalence set are generated by an equivalent transformation, all the elements in the equivalence set are solutions of the ordinary differential equation, the ordinary differential equation is an invariant function of the equivalent transformation, the variable

$$z = ( t , z , \frac{dz}{dt} )$$

is defined as the solution of the neural ordinary differential equation

$${F}_{θ} ( z ) = {F}_{θ} ( t , z , \frac{dz}{dt} ) = \frac{dz}{dt} - {f}_{x , θ} ( t , z ) = 0 , and θ = \{ ϑ , φ \}$$

is the parameter of the neural network, the invariance condition is as follows:

$${F}_{θ}^{*} ( z ) = {F}_{θ}^{*} ( gz ) ,$$

wherein, g∈G is the time-scale transformation;

$${F}_{θ}^{*}$$

is an ultimately desired invariant function, i.e., both z and gz are the solutions of

$${F}_{θ}^{*}$$

and a set of equivalent solutions is generated by applying the transformation g∈G to z,
by using a Taylor transformation, the above invariance condition is deduced as:

$${XF}_{θ} = ξ ( z ) \frac{\partial }{\partial z} {F}_{θ} = 0 ,$$

wherein,

$$ξ ( z ) = {[ \frac{\partial {g}_{s} ( z )}{\partial s} ]}_{s = 0}$$

is a vector field of the time-scale transformation g, s is the parameter of the time-scale transformation, and

$$X = ξ ( z ) \frac{\partial }{\partial z}$$

is an infinitesimal generator.

In a preferred embodiment of the aeroengine remaining useful life prediction method based on a neural ordinary differential equation under symmetric regularization, an expression of the infinitesimal generator is denoted as

$$X = ξ ( t , z ) \frac{\partial }{\partial t} + η ( t , z ) \frac{\partial }{\partial z} ,$$

and ξ and η are vector fields of the invariance the variables t and z, respectively, considering the first-order differential term

$$\frac{dz}{dt} ,$$

the invariance condition takes into account the first-order prolongation of the infinitesimal generator, denoted as X⁽¹⁾, and the invariance condition is derived as follows:

$${{X}^{( 1 )} {F}_{θ} \vert}_{{F}_{θ} = 0} = 0 ,$$

wherein.

$${X}^{( 1 )} = X + {η}_{1} ( t , z ) \frac{\partial }{\partial {z}^{1}} = ξ \frac{\partial }{\partial t} + η \frac{\partial }{\partial z} + ( \frac{\partial η}{\partial t} + ( \frac{\partial η}{\partial z} - \frac{\partial ξ}{\partial t} ) {z}^{1} - {( {z}^{1} )}^{2} \frac{\partial ξ}{\partial z} ) \frac{\partial }{\partial {z}^{1}} , and$$

$${z}^{1} = \frac{dz}{dt} ,$$

hence, the invariance condition is simplified as:

$${X}^{( 1 )} {F}_{θ} = \frac{\partial η}{\partial t} + ( \frac{\partial η}{\partial z} - \frac{\partial ξ}{\partial t} ) {f}_{x , θ} - {( {f}_{x , θ} )}^{2} \frac{\partial ξ}{\partial z} - ξ \frac{\partial {f}_{x , θ}}{\partial t} - η \frac{\partial {f}_{x , θ}}{\partial z} = 0 ,$$

wherein, ξ and η are vector fields of the variables t and z, respectively, and they are determined by the form of the equivalent transformation g.

In a preferred embodiment of the aeroengine remaining useful life prediction method based on a neural ordinary differential equation under symmetric regularization, the latent variable z is a power function characterizing the degradation process, z(t)=kt^{α}, k, and α are the function coefficients, then the vector fields ξ and η are obtained as follows:

$$\{ \begin{matrix}\tilde{t} = {e}^{s} t \\ \tilde{z} = {e}^{- s α} z\end{matrix} ⇒ \{ \begin{matrix}{{ξ = \frac{\partial \tilde{t} ( t \vert s )}{\partial s} \vert}_{s = 0} = {e}^{s} t \vert}_{s = 0} = t \\ {{η = \frac{\partial \tilde{z} ( z \vert s )}{\partial s} \vert}_{s = 0} = - α {e}^{- α s} z \vert}_{s = 0} = - α z\end{matrix} ,$$

wherein, \tilde{t} and \tilde{z} are equivalent solutions after the time-scale transformation, and the vector fields ξ and η are substituted into the invariance condition to obtain the symmetry regularization:

$${J}_{ODE} = ‖ t \frac{\partial {f}_{x , θ}}{\partial t} - α z \frac{\partial {f}_{x , θ}}{\partial z} + 2 {f}_{x , θ} + 2 α {f}_{x , θ} ‖ ,$$

or, z is an exponential function, and the corresponding symmetry regularization is:

$${J}_{ODE} = ‖ t \frac{\partial {f}_{x , θ}}{\partial t} - {e}^{- 1} z \frac{\partial {f}_{x , θ}}{\partial z} + 2 {f}_{x , θ} + 2 {e}^{- 1} {f}_{x , θ} ‖$$

it is found that both are able to be described with a same expression:

$${J}_{ODE} = ‖ t \frac{\partial {f}_{x , θ}}{\partial t} + 2 {f}_{x , θ} + α ( 2 {f}_{x , θ} - z \frac{\partial {f}_{x , θ}}{\partial z} ) ‖$$

wherein, α is the function coefficient.

In a preferred embodiment of the aeroengine remaining useful life prediction method based on a neural ordinary differential equation under symmetric regularization, in Step e, the training sample set is input into the neural network under the symmetry regularization to obtain the latent variable process corresponding to the training sample set, and by combining the time information, the remaining useful life of the latent variable process in the test sample set is estimated with a k-nearest neighbor algorithm to obtain remaining useful life sample pairs [(z₁,y₁), . . . , (z_{N},y_{N})], wherein yᵢ is a remaining useful life label.

In a preferred embodiment of the aeroengine remaining useful life prediction method based on a neural ordinary differential equation under symmetric regularization, in Step e, the neural network includes two parts of the neural ordinary differential equation and the Fourier neural operator, wherein, the neural ordinary differential equation models the latent variable zᵢ, and the Fourier neural operator maps the latent variable zᵢ to the signal space, i.e., the reconstructed signal \hat{x}ᵢ; then finally an optimization objective for all the parameters consists of a reconstruction loss

$${‖ {x}_{i} - {\hat{x}}_{i} ‖}_{2}^{2}$$

and symmetry regularization J_{ODE}, since the latent variable process is restricted to one continuous bounded function space, the general approximation theorem of neural networks guarantees convergence.

In a preferred embodiment of the aeroengine remaining useful life prediction method based on a neural ordinary differential equation under symmetric regularization.

A latent variable is a feature in a neural network, is a variable (latent); the neural network is a function and the latent variable is an input variable to this function.

In one embodiment, a flight cycle is one complete operational envelope of the aeroengine, including the take-off, cruise, and landing phases, the monitoring signal sampling frequency is 1 Hz, and one flight cycle lasts from about 1 hour to about 5 hours.

In one embodiment, after temporal segmentation based on the flight cycle, the unequal-length samples are downsampled at a ratio of 1:15, and the downsampled samples are zero padded to equal-length samples; from 15 aeroengines, 9 are selected as the training set and the remaining 6 as the test sample set.

In one embodiment, the number of sensor monitoring variables includes a gas path parameter and a temperature parameter.

In one embodiment, as shown in FIG. 1, the aeroengine remaining useful life prediction method based on a neural ordinary differential equation under symmetric regularization includes the following steps:

in the first step, the sensors such as pressure and temperature sensors are used to collect monitoring data for the full-lifecycle of the aeroengine, with a sampling frequency of 1 Hz. Temporal segmentation is performed on the full-lifecycle data according to the flight cycle X=[x₁, . . . , x_{N}], and each sample is a multivariate time series denoted as xᵢ ∈R^{p*T}^{ᵢ} The number of variables p is the number of sensor monitoring variables, including an air path parameter, a temperature parameter, and so on. The samples of unequal length are downsampled at a ratio of 1:15 and then zero-padded to ensure all samples have the same length. Out of 15 aeroengines, 9 are selected as the training sample set, and the remaining 6 are used as the test sample set. A mean and a variance are calculated on the training sample set to normalize the samples to within a range of [0, 1], and the mean and variance are applied to the test sample set for normalization.

In the second step, the first-order neural ordinary differential equation is established to perform continuous temporal modeling on a degradation process in a latent variable space, and the first-order neural ordinary differential equation consists of an encoder and a multi-layer non-linear perceptron, wherein the encoder is selected as ResNet, which reduces the high-dimensional residual signal in dimensionality to a low-dimensional space; the multi-layer non-linear perceptron is used to describe the evolution trajectory of the latent variable over time. The functional form of the neural network is:

$$\frac{d z ( t )}{d t} = f ( t , z ( t ) , Δ x ( t ) ) = {h}_{ϑ} ( Δ x ( t ) ) \cdot {f}_{φ} ( t , z ( t ) )$$

wherein, z(t) is a latent variable, Δx(t) is a residual signal, h_{ϑ} is an encoder network, and consists of three layers of residual connection network and two non-linear dimensionality reduction layers, the high-dimensional signal is reduced in dimensionality to a low-dimensional feature, an activation function for a final output layer of h_{ϑ} is selected to be a tanh function; ƒ_{φ} is a multi-layer non-linear perceptron, consisting of three linear layers and non-linear activation functions, the activation function of an intermediate layer is selected as a ReLU function, and the activation function of an output layer is selected as a tanh function, and the tanh function constrains value ranges of h_{ϑ} and ƒ_{φ} within a bounded interval, ensuring that they satisfy the Lipschitz condition; and ϑ and φ are parameters of the neural network. The residual signal provides time-varying information for the first-order neural ordinary differential equation, and is calculated from the residual between the actual signal and the signal in an ideal health state,

$$Δ {x}_{i} = {x}_{i} - {x}_{i}^{′} ,$$

wherein, to obtain a signal in the ideal health state, a system transfer function in the ideal health state is constructed by a Fourier neural operator independent of the third step in the form of:

$${x}_{j} = {FNO}^{′} ( {w}_{j} ) , j = 1 , 2 , … , m$$

wherein, xⱼ and wⱼ are the monitoring parameter and the operating condition parameter in the health state, respectively, and FNO′ is the system transfer function in the ideal health state.

In the third step, a Fourier neural operator is established to approximate a transfer function of a physical system that degrades over time. The input of the Fourier neural operator consists of time-varying operating condition parameters and latent variables, while the output is the system response monitoring parameters. By comparing the output of the operator with the actual wherein monitoring parameters, the loss function of the neural network is obtained as

$${‖ {x}_{i} - {\hat{x}}_{i} ‖}_{2}^{2} ,$$

wherein xᵢ represents the actual monitoring parameter and \hat{x}ᵢ represents the output of the neural operator. The Fourier neural operator consists of a lifting layer, an iterative Fourier layer, and a projection layer, the lifting layer maps the low-dimensional latent variable zᵢ to a high dimensional space; the iterative Fourier layer consists of four forward and inverse Fourier transforms, in each iteration, an input variable undergoes a Fourier forward transform, followed by a linear transformation, and finally a Fourier inverse transform; the projection layer finally maps a feature to a signal space, i.e., the reconstructed signal \hat{x}ᵢ.

In the fourth step, symmetry regularization is established, which is derived from an invariance condition of the ordinary differential equation, the invariance condition of the ordinary differential equation is defined as that a new solution obtained by applying a certain equivalent transformation to the solution of the ordinary differential equation still satisfies the equation. The variable

$$z = ( t , z , \frac{dz}{dt} )$$

is defined as the solution of the neural ordinary differential equation

$${F}_{θ} ( z ) = {F}_{θ} ( t , z , \frac{dz}{dt} ) = \frac{dz}{dt} - {f}_{x , θ} ( t , z ) = 0 , and θ = \{ ϑ , φ \}$$

is the parameter of the neural network, the invariance condition is as follows:

$${F}_{θ}^{*} ( z ) = {F}_{θ}^{*} ( gz )$$

wherein g∈G is the equivalent transformation and defines the time-scale transformation between different degradation trajectories;

$${F}_{θ}^{*}$$

is an ultimately desired invariant function, i.e., both z and gz are the solutions of

$${F}_{θ}^{*}$$

and a set of equivalent solutions is generated by applying the transformation g∈G to z. By using a Taylor transformation, the above invariance condition is deduced as:

$${XF}_{θ} = ξ ( z ) \frac{\partial }{\partial z} {F}_{θ} = 0$$

wherein,

$$ξ ( z ) = {[ \frac{\partial {g}_{s} ( z )}{\partial s} ]}_{s = 0}$$

is a vector field of the time-scale transformation g, s is the parameter of the time-scale transformation, and

$$X = ξ ( z ) \frac{\partial }{\partial z}$$

is defined as an infinitesimal generator. Considering the first-order differential term

$$\frac{dz}{dt} ,$$

the invariance condition takes into account the first-order prolongation of the infinitesimal generator, denoted as X⁽¹⁾, and the invariance condition is derived as follows:

$${X}^{( 1 )} {F}_{θ} {\vert}_{{F}_{θ} = 0} = 0$$

wherein

$${X}^{( 1 )} = X + {η}_{1} ( t , z ) \frac{\partial }{\partial {z}^{1}} = ξ \frac{\partial }{\partial t} + η \frac{\partial }{\partial z} + ( \frac{\partial η}{\partial t} + ( \frac{\partial η}{\partial z} - \frac{\partial ξ}{\partial t} ) {z}^{1} - {( {z}^{1} )}^{2} \frac{\partial ξ}{\partial z} ) \frac{\partial }{\partial {z}^{1}} , and {z}^{1} = \frac{dz}{dt} ,$$

hence, the invariance condition is simplified as:

$${X}^{( 1 )} {F}_{θ} = \frac{\partial η}{\partial t} + ( \frac{\partial η}{\partial z} - \frac{\partial ξ}{\partial t} ) {f}_{x , θ} - {( {f}_{x , θ} )}^{2} \frac{\partial ξ}{\partial z} - ξ \frac{\partial {f}_{x , θ}}{\partial t} - η \frac{\partial {ξ}_{x , θ}}{\partial z} = 0 ,$$

wherein, ξ and η are vector fields of the variables t and z, respectively, and they are determined by the form of the equivalent transformation g. The vector fields ξ and η are determined by the time-scale transformation, and without loss of generality, it is assumed that the latent variable process z is a power function, z(t)=kt^{α}, k, and α are the function coefficients, then the vector fields & and n are obtained as follows:

$$\{ \begin{matrix}\tilde{t} = {e}^{s} t \\ \tilde{z} = {e}^{- s α} z\end{matrix} ⇒ \{ \begin{matrix}ξ = \frac{\partial \tilde{t} ( t \vert s )}{\partial s} {\vert}_{s = 0} = {e}^{s} t {\vert}_{s = 0} = t \\ η = \frac{\partial \tilde{z} ( z \vert s )}{\partial s} {\vert}_{s = 0} = - α {e}^{- α s} z {\vert}_{s = 0} = - α z\end{matrix}$$

wherein, \tilde{t} and \tilde{z} are equivalent solutions after the time-scale transformation, and the vector fields ξ and η are substituted into the invariance condition to obtain the symmetry regularization:

$${J}_{ODE} = ‖ t \frac{\partial {f}_{x , θ}}{\partial t} - α z \frac{\partial {f}_{x , θ}}{\partial z} + 2 {f}_{x , θ} + 2 α {f}_{x , θ} ‖ ,$$

similarly, it is assembled that z is an exponential function, and the corresponding symmetry regularization is:

$${J}_{ODE} = ‖ t \frac{\partial {f}_{x , θ}}{\partial t} - {e}^{- 1} z \frac{\partial {f}_{x , θ}}{\partial z} + 2 {f}_{x , θ} + 2 {e}^{- 1} {f}_{x , θ} ‖$$

it is found that both are able to be described with a same expression, and the symmetry regularization is:

$${J}_{ODE} = ‖ t \frac{\partial {f}_{x , θ}}{\partial t} + 2 {f}_{x , θ} + α ( 2 {f}_{x , θ} - z \frac{\partial {f}_{x , θ}}{\partial z} ) ‖$$

wherein, α is the function coefficient.

In the fifth step, the training sample set is input into the neural network under the symmetry regularization to obtain the latent variable process corresponding to the training sample set, and by combining the time information, remaining useful life sample pairs [(z₁,y₁), . . . , (z_{N},y_{N})] are obtained, wherein yᵢ is a remaining useful life label; likewise, the test sample set is input into the neural network under symmetric regularization to obtain a latent variable process corresponding to the test sample set, the remaining useful life of the latent variable process in the test sample set is estimated according to a k-nearest neighbor algorithm; the training process of the neural network includes two parts of the neural ordinary differential equation and the Fourier neural operator, wherein, the neural ordinary differential equation models the latent variable zᵢ, and the Fourier neural operator maps the latent variable zᵢ to the signal space, i.e., the reconstructed signal \hat{x}ᵢ; then finally an optimization objective for all the parameters consists of a reconstruction loss

$${‖ {x}_{i} - {\hat{x}}_{i} ‖}_{2}^{2}$$

and a symmetry regularization J_{ODE}, since the latent variable process is restricted to one continuous bounded function space, the general approximation theorem of neural networks guarantees convergence. Optionally, the present embodiment is iteratively trained 500 times in total.

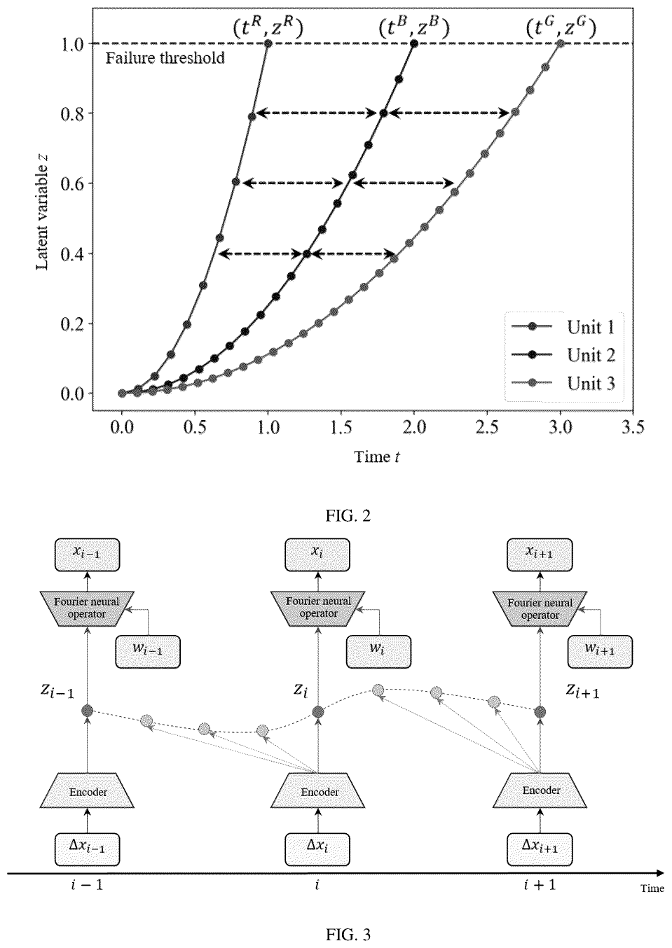

FIG. 2 is a schematic diagram illustrating the time-scale transformation of the degradation process. The three curves in red, blue, and green in the figure represent three different degradation process trajectories, respectively. It can be observed that due to influences from environmental variables, operating conditions, manufacturing errors, and other factors, the time for different degradation processes to reach the failure threshold varies. This variation can lead to generalization issues during the modeling process. This disclosure proposes that such variations can be explained by time-scale transformations between different trajectories, thereby introducing the invariance condition and symmetry regularization of neural ordinary differential equations.

FIG. 3 is a schematic diagram illustrating the estimation of the latent variable process. Firstly, the neural ordinary differential equation is used to perform temporal modeling on the latent variable z. The residual signal Δx passes through an encoder to enhance the representation of the latent variable. Subsequently, the operating condition parameter w and latent variable z are input into the Fourier neural operator to estimate the system monitoring parameter x.

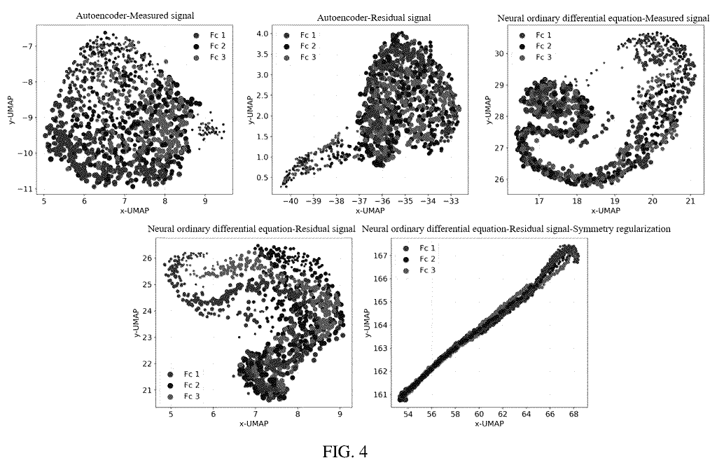

FIG. 4 is a schematic diagram illustrating the comparison of latent variable processes for the aeroengine according to an embodiment of the present disclosure, and it can be seen that the neural ordinary differential equation under the symmetry regularization can obtain the latent variable processes with a consistent structure, thereby avoiding post-processing steps such as normalization that are typically required for health indicators.

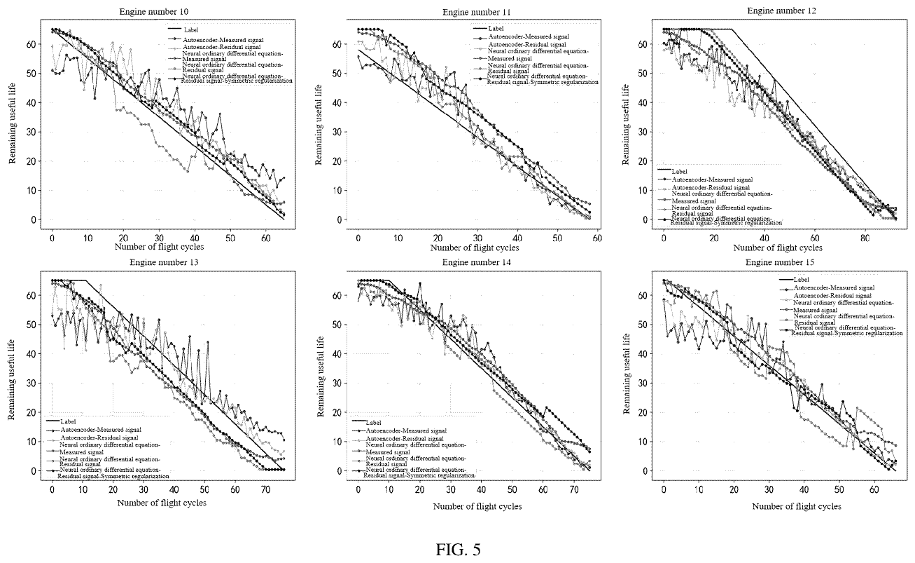

FIG. 5 is a schematic diagram illustrating the aeroengine remaining useful life prediction according to an embodiment of the present disclosure, and it can be seen that the evaluation metrics for the prediction results include the Root Mean Square Error (RMSE) and the Score function, and the tests were conducted on two aeroengine fleets, namely N-CMAPSS-DS03 and N-CMAPSS-DS04. The experimental results were compared with those of three models: Deep Gaussian Process, Bayesian Transformer, and Neural Ordinary Differential Equation. The results are shown in Table 1.

| | N-CMAPSS-DS03 | | N-CMAPSS-DS04 | |
|---|---|---|---|---|
| | Root Mean | | Root Mean | |
| | Square | | Square | |
| | Error | Score | Error | Score |
| | (RMSE) | function | (RMSE) | function |
| Deep Gaussian | 7.26 | 23029 . . . 42 | 9.86 | 36310.33 |
| Process | | | | |
| Bayesian | 5.815 | 260.014 | 7.749 | 306.26 |
| Transformer | | | | |
| Neural | 6.461 | 278.897 | 7.523 | 284.739 |
| Ordinary | | | | |
| Differential | | | | |
| Equation | | | | |
| Neural | 5.687 | 248.803 | 7.123 | 286.848 |
| Ordinary | | | | |
| Differential | | | | |
| Equation Under | | | | |
| Symmetric | | | | |
| Regularization | | | | |

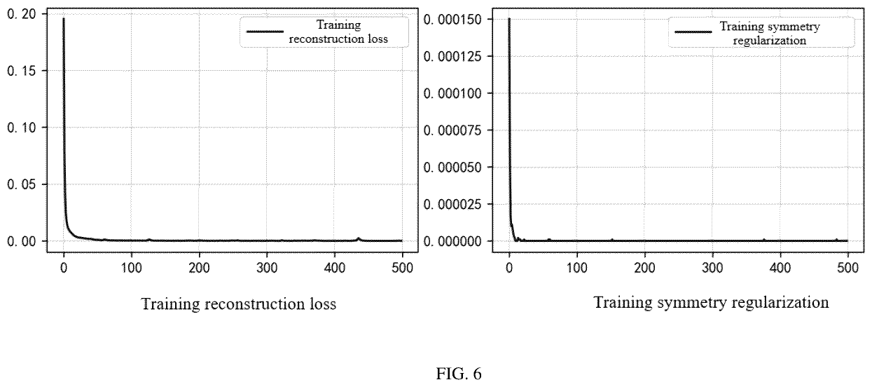

FIG. 6 is a schematic diagram of the neural network training convergence process of the embodiment of the present disclosure, and it can be seen that in the training process of the neural network, both the reconstruction loss and the symmetry regularization can converge faster, and fluctuation is small. This fast convergence process benefits from the rational design of the neural ordinary differential equation, i.e., the tanh function makes the neural ordinary differential equation satisfy the Lipchitz condition, thereby constraining the latent variable process to a continuous bounded variable process, and in turn, the universal approximation theorem of the neural network guarantees the convergence of the neural network.

In this embodiment, the symmetry regularization enables the neural ordinary differential equation to be an invariant function with respect to time-scale transformations of different latent variable processes, thereby giving a consistent structure to these processes. This eliminates the need for post-processing steps such as normalization, which are typically required for metrics like health indicators, and enhances the interpretability of latent variables as well as the performance of remaining useful life prediction. As evident from the results presented in FIG. 4, FIG. 5, and Table 1, the proposed symmetric regularization neural ordinary differential equation demonstrates superior performance across evaluation metrics, thus validating the superiority of this prediction method.

Limiting. Those skilled in the art can make many forms under the inspiration of the present specification and without departing from the scope of the claims of the present disclosure, all of which fall within the scope of the protection of the present disclosure.

1. An aeroengine remaining useful life prediction method based on a neural ordinary differential equation under symmetric regularization, comprising the steps of:
Step a, collecting monitoring parameters of a full-lifecycle of an aeroengine with sensors, the monitoring parameters comprising outlet temperatures and air pressures of a compressor and a turbine, performing temporal segmentation on the monitoring parameters according to a number of flight cycles, obtaining samples of fixed length through downsampling and zero-padding, respectively constructing a training sample set and a test sample set, and performing normalization processing;
Step b, establishing a first-order neural ordinary differential equation to perform continuous temporal modeling on a degradation process in a latent variable space, calculating a residual signal as a time-varying signal to enhance the representation capability of the neural ordinary differential equation, so that a solution of the equation depends simultaneously on an initial value and the time-varying residual signal;
Step c, establishing a Fourier neural operator to approximate a transfer function of a physical system, mapping an operating condition parameter and a latent variable to a sensor response parameter, so as to construct a loss function of the neural network;
Step d, considering a time-scale transformation between different degradation processes, based on an invariance condition of the first-order ordinary differential equation, constructing a symmetry regularization term to constrain the invariance of the neural ordinary differential equation to the time-scale transformation, obtaining a latent variable process with a consistent structure; and
Step e, inputting the training sample set and the test sample set into the neural network to obtain latent variable processes corresponding to the training sample set and the test sample set, respectively, estimating the remaining useful life of the test sample set according to nearest neighbor samples in the training sample set.

2. The aeroengine remaining useful life prediction method based on a neural ordinary differential equation under symmetric regularization according to claim 1, wherein, preferably, in Step a, the monitoring parameters X=[x₁, . . . , x_{N}] of the full-lifecycle are divided by the number of flight cycles, each cycle is divided into one sample, each sample is a multivariate time series denoted as xᵢ ∈R^{p*T}^{ᵢ}, the number of variables p is the number of sensor monitoring variables, and a time length Tᵢ of each sample is 1353 time steps through downsampling and zero-padding; a mean and a variance are calculated on the training sample set to normalize the samples to within a range of [0, 1], and the mean and variance are applied to the test sample set for normalization.

3. The aeroengine remaining useful life prediction method based on a neural ordinary differential equation under symmetric regularization according to claim 1, wherein, in Step b, the first-order neural ordinary differential equation is established in a form of:
$${z}_{i} = {z}_{0} + {\int }_{0}^{i} f ( t , {z}_{t} , Δ {x}_{i} ) d t , {z}_{0} = 0 ,$$
wherein, zᵢ∈R^{d} is an latent variable, which is used for approximating a real but unknown degradation process, i represents the number of cycles of the aeroengine, i.e., the health state of each cycle is represented by a zᵢ vector, d is the dimension of the latent variable; Z₀ is an initial value of the ordinary differential equation, and is set to 0 to represent an initial value state of the degradation process; t is an integral variable; ƒ is a neural network, which is used for describing the temporal relationship of the latent variable; Δxᵢ is a residual signal, by adding the time-varying residual signal, the solution of the equation becomes dependent on both the initial value and the time-varying signal, wherein a specific functional form of the neural network ƒ is:
$$\frac{d z ( t )}{d t} = f ( t , z ( t ) , Δ x ( t ) ) = {h}_{ϑ} ( Δ x ( t ) ) \cdot {f}_{φ} ( t , z ( t ) )$$
wherein, h_{ϑ} is an encoder network, consisting of three layers of residual connection network and two non-linear dimensionality reduction layers, the network reduces high-dimensional signals to low-dimensional features, an activation function for a final output layer of h_{ϑ} is selected to be a tanh function; ƒ_{φ} is a multi-layer non-linear perceptron, consisting of three linear layers and non-linear activation functions, the activation function of an intermediate layer is selected as a ReLU function, and the activation function of an output layer is selected as a tanh function, and the tanh function constrains value ranges of h_{ϑ} and ƒ_{φ} within a bounded interval, ensuring that they satisfy the Lipschitz condition; and ϑ and φ are parameters of the neural network.

4. The aeroengine remaining useful life prediction method based on a neural ordinary differential equation under symmetric regularization according to claim 3, wherein the residual signal is the residual between an actual signal and a signal in an ideal health state:
$$Δ {x}_{i} = {x}_{i} - {x}_{i}^{′} ,$$
wherein,
$${x}_{i}^{′}$$
is the monitoring parameter in the ideal health state, which is controlled only by the operating condition parameter wᵢ, an independent Fourier neural operator is constructed to approximate a system transfer function in the ideal health state:
$${x}_{j} = {FNO}^{′} ( {w}_{j} ) , j = 1 , 2 , … , m ,$$
wherein, j represents an observed sequence number of the health state, with a maximum value of m, FNO′ is the system transfer function in the ideal health state, then FNO′ is applied to a full-lifecycle sequence to obtain the monitoring parameter in the ideal health state:
$${x}_{i}^{′} = {FNO}^{′} ( {w}_{i} ) , i = 1 , 2 … , N .$$

5. The aeroengine remaining useful life prediction method based on a neural ordinary differential equation under symmetric regularization according to claim 1, wherein, in Step c, the Fourier neural operator constructs a mapping from the operating condition parameter and the latent variable to the sensor monitoring parameter:
$${\hat{x}}_{i} = FNO ( {w}_{i} , {z}_{i} ) ,$$
wherein, wᵢ∈R^{S*T}^{ᵢ} represents the operating condition parameter, S is the number of the operating condition parameters, zᵢ is the latent variable, \hat{x}ᵢ is the reconstructed sensor monitoring parameter, and FNO is the Fourier neural operator, based on the actual signal x; and the reconstructed signal \hat{x}ᵢ, a loss function of the neural network is obtained as
$${‖ {x}_{i} - {\hat{x}}_{i} ‖}_{2}^{2} ,$$
the Fourier neural operator FNO consists of a lifting layer, an iterative Fourier layer, and a projection layer, and the lifting layer maps the low-dimensional latent variable zᵢ to a high dimensional space; the iterative Fourier layer consists of four forward and inverse Fourier transforms, in each iteration, an input variable undergoes a Fourier forward transform, followed by a linear transformation, and finally a Fourier inverse transform; the projection layer finally maps a feature to a signal space, i.e., the reconstructed signal \hat{x}ᵢ.

6. The aeroengine remaining useful life prediction method based on a neural ordinary differential equation under symmetric regularization according to claim 1, wherein, in Step d, the time-scale transformation between different degradation processes involves the mutual conversion of these processes through scale transformations along the time axis, an invariance condition of the first-order ordinary differential equation is that there exists one equivalence set of solutions of the first-order ordinary differential equation, the elements in the equivalence set are generated by an equivalent transformation, all the elements in the equivalence set are solutions of the ordinary differential equation, the ordinary differential equation is an invariant function of the equivalent transformation, the variable
$$z = ( t , z , \frac{d z}{dt} )$$
is defined as the solution of the neural ordinary differential equation
$${F}_{θ} ( z ) = {F}_{θ} ( t , z , \frac{d z}{d t} ) = \frac{d z}{d t} - {f}_{x , θ} ( t , z ) = 0 , and θ = \{ ϑ , φ \}$$
is the parameter of the neural network, the invariance condition is as follows:
$${F}_{θ}^{*} ( z ) = {F}_{θ}^{*} ( g z ) ,$$
wherein, g∈G is the time-scale transformation;
$${F}_{θ}^{*}$$
is an ultimately desired invariant function, i.e., both z and gz are the solutions of
$${F}_{θ}^{*}$$
and a set of equivalent solutions is generated by applying the transformation g∈G to z,
by using a Taylor transformation, the above invariance condition is deduced as:
$${XF}_{θ} = ξ ( z ) \frac{\partial }{\partial z} {F}_{θ} = 0 ,$$
wherein,
$$ξ ( z ) = {[ \frac{\partial {g}_{s} ( z )}{\partial s} ]}_{s = 0}$$
is a vector field of the time-scale transformation g, s is the parameter of the time-scale transformation, and
$$X = ξ ( z ) \frac{\partial }{\partial z}$$
is an infinitesimal generator.

7. The aeroengine remaining useful life prediction method based on a neural ordinary differential equation under symmetric regularization according to claim 6, wherein an expression of the infinitesimal generator is denoted as
$$X = ξ ( t , z ) \frac{\partial }{\partial t} + η ( t , z ) \frac{\partial }{\partial z} ,$$
and ξ and η are vector fields of the variables t and z, respectively, considering the first-order differential term
$$\frac{dz}{dt} ,$$
the invariance condition takes into account the first-order prolongation of the infinitesimal generator, denoted as X⁽¹⁾, and the invariance condition is derived as follows:
$${X}^{( 1 )} {F}_{θ} {\vert}_{{F}_{θ} = 0} = 0 ,$$
wherein
$${X}^{( 1 )} = X + {η}_{1} ( t , z ) \frac{\partial }{\partial {z}^{1}} = ξ \frac{\partial }{\partial t} + η \frac{\partial }{\partial z} + ( \frac{\partial η}{\partial t} + ( \frac{\partial η}{\partial z} - \frac{\partial ξ}{\partial t} ) {z}^{1} - {( {z}^{1} )}^{2} \frac{\partial ξ}{\partial z} ) \frac{\partial }{\partial {z}^{1}} ,$$
$$and {z}^{1} = \frac{dz}{dt} ,$$
hence, the invariance condition is simplified as:
$${X}^{( 1 )} {F}_{θ} = \frac{\partial η}{\partial t} + ( \frac{\partial η}{\partial z} - \frac{\partial ξ}{\partial t} ) {f}_{x , θ} - {( {f}_{x , θ} )}^{2} \frac{\partial ξ}{\partial z} - ξ \frac{\partial {f}_{x , θ}}{\partial t} - η \frac{\partial {f}_{x , θ}}{\partial z} = 0 ,$$
wherein, ξ and η are vector fields of the variables t and z, respectively, and they are determined by the form of the equivalent transformation g.

8. The aeroengine remaining useful life prediction method based on a neural ordinary differential equation under symmetric regularization according to claim 7, wherein the latent variable z is a power function characterizing the degradation process, z(t)=kt^{α}, k, and α are the function coefficients, then the vector fields ξ and η are obtained as follows:
$$\{ \begin{matrix}\tilde{t} = {e}^{s} t \\ \tilde{z} = {e}^{- s α} z\end{matrix} ⇒ \{ \begin{matrix}ξ = \frac{\partial \tilde{t} ( t \vert s )}{\partial s} {\vert}_{s = 0} = {e}^{s} t {\vert}_{s = 0} = t \\ η = \frac{\partial \tilde{z} ( z \vert s )}{\partial s} {\vert}_{s = 0} = - α {e}^{- α s} z {\vert}_{s = 0} = - α z\end{matrix} ,$$
wherein, \tilde{t} and \tilde{z} are equivalent solutions after the time-scale transformation, and the vector fields ξ and η are substituted into the invariance condition to obtain the symmetry regularization:
$${J}_{ODE} = ‖ t \frac{\partial {f}_{x , θ}}{\partial t} - α z \frac{\partial {f}_{x , θ}}{\partial z} + 2 {f}_{x , θ} + 2 α {f}_{x , θ} ‖ ,$$
or, z is an exponential function, and the corresponding symmetry regularization is:
$${J}_{ODE} = ‖ t \frac{\partial {f}_{x , θ}}{\partial t} - {e}^{- 1} z \frac{\partial {f}_{x , θ}}{\partial z} + 2 {f}_{x , θ} + 2 {e}^{- 1} {f}_{x , θ} ‖$$
it is found that both are able to be described with a same expression:
$${J}_{ODE} = ‖ t \frac{\partial {f}_{x , θ}}{\partial t} + 2 {f}_{x , θ} + α ( 2 {f}_{x , θ} - z \frac{\partial {f}_{x , θ}}{\partial z} ) ‖$$
wherein, α is the function coefficient.

9. The aeroengine remaining useful life prediction method based on a neural ordinary differential equation under symmetric regularization according to claim 1, wherein, in Step e, the training sample set is input into the neural network under the symmetry regularization to obtain the latent variable process corresponding to the training sample set, and by combining the time information, the remaining useful life of the latent variable process in the test sample set is estimated with a k-nearest neighbor algorithm to obtain remaining useful life sample pairs [(z₁,y₁), . . . , (z_{N},y_{N})], wherein yᵢ is a remaining useful life label.

10. The aeroengine remaining useful life prediction method based on a neural ordinary differential equation under symmetric regularization according to claim 1, wherein, in Step e, the neural network comprises two parts of the neural ordinary differential equation and the Fourier neural operator, wherein, the neural ordinary differential equation models the latent variable zᵢ, and the Fourier neural operator maps the latent variable zᵢ to the signal space, i.e., the reconstructed signal ît; then finally an optimization objective for all the parameters consists of a reconstruction loss
$${‖ {x}_{i} - {\hat{x}}_{i} ‖}_{2}^{2}$$
and symmetry regularization J_{ODE}, since the latent variable process is restricted to one continuous bounded function space, the general approximation theorem of neural networks guarantees convergence.
